(19) United States
(12) Patent Application Publication
(10) Pub. No.: US 2016/0211524 A1
(43) Pub. Date: Jul. 21, 2016

(54) ELECTRODE STRUCTURE TO REDUCE POLARIZATION AND INCREASE POWER DENSITY OF BATTERIES

(71) Applicant: Nissan North America, Inc., Franklin, TN (US)

(72) Inventors: XIAOGUANG HAO, Farmington Hills, MI (US); KENZO OSHIHARA, Farmington Hills, MI (US)

(21) Appl. No.: 14/597,353

(22) Filed: Jan. 15, 2015

(51) Int. Cl. H01M 4/62; H01M 4/505; H01M 4/525; H01M 4/04; H01M 4/36; H01M 4/136; H01M 4/58; H01M 4/131; H01M 4/38

(52) U.S. Cl. CPC H01M 4/625; H01M 4/131; H01M 4/505; H01M 4/525; H01M 4/382; H01M 4/364; H01M 4/136; H01M 4/581; H01M 4/0404; H01M 2220/20

(57) ABSTRACT

An electrode comprises a current collector, a conductive buffer layer formed on the current collector consisting essentially of carbon and a binder, and an active material layer formed on the buffer layer. Another conductive buffer layer can be formed on an opposing side of the current collector, with the active material formed on this other buffer layer. The active material layer can be either an anode active material layer or a cathode active material layer.

### TECHNICAL FIELD

This disclosure relates to an electrode structure that reduces battery polarization and increases the energy and power density of the battery, and in particular, an electrode having a carbon layer between the active material and the current collector.

### BACKGROUND

Hybrid vehicles (HEV) and electric vehicles (EV) use chargeable-dischargeable power sources. Secondary batteries such as lithium-ion batteries are typical power sources for HEV and EV vehicles. Lithium-ion secondary batteries typically use carbon, such as graphite, as the anode electrode. Graphite materials are very stable and exhibit good cycle-life and durability. However, graphite material suffers from a low theoretical lithium storage capacity of only about 372 mAh/g. This low storage capacity results in poor energy density of the lithium-ion battery and low electric mileage per charge.

To increase the theoretical lithium storage capacity, silicon has been added to active materials. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon causes particle cracking and pulverization. This deteriorative phenomenon escalates to the electrode level, leading to electrode delamination, loss of porosity, electrical isolation of the active material, increase in electrode thickness, rapid capacity fade and ultimate cell failure.

### SUMMARY

An electrode is disclosed that comprises a current collector, a conductive buffer layer formed on the current collector and consisting essentially of carbon and a binder and an active material layer formed on the buffer layer. Another conductive buffer layer can be formed on an opposing side of the current collector, with the active material formed on this other buffer layer. The active material layer can be either an anode active material layer or a cathode active material layer. Other aspects of the electrode embodiments will be described herein.

A method of preparing the electrode embodiments disclosed herein and configured to reduce polarization and improve energy density comprise coating a first surface of a current collector with a conductive buffer layer consisting essentially of carbon and a binder and coating the buffer layer with an active material layer comprising a binder.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIGS. 1A and 1B are schematic diagrams of a conventional electrode before lithiation and a conventional lithiated electrode, respectively;

FIGS. 2A and 2B are schematic diagrams of an electrode having a conductive buffer layer before lithiation and a lithiated electrode having a conductive buffer layer, respectively;

FIG. 3A is a cross section view of an electrode having a conductive buffer layer with higher porosity;

FIG. 3B is a cross section view of an electrode having a conductive buffer layer with lower porosity;

FIG. 4 is a cross sectional view of an electrode having conductive buffer layers as disclosed herein;

FIG. 5 is a cross sectional view of another embodiment of an electrode having a conductive buffer layer as disclosed herein;

FIG. 6 is a cross sectional view of another embodiment of a bi-polar electrode having conductive buffer layers as disclosed herein;

FIG. 7A is graph illustrating the polarization of a conventional electrode;

FIG. 7B is a graph illustrating the polarization of an electrode having a conductive buffer layer disclosed herein;

FIG. 8 is a flow diagram of a method of making an electrode as disclosed herein; and

FIG. 9 is a flow diagram of another method of making an electrode as disclosed herein.

### DETAILED DESCRIPTION

Because the carbon material used in electrodes of conventional batteries, such as lithium ion batteries or sodium ion batteries, suffers from a low specific capacity, the conventional battery has poor energy density even though there is small polarization and good stability. To increase the energy density of batteries using carbon electrodes, alternative active materials with higher energy densities are required. Silicon, tin, germanium, cobalt oxide, manganese oxide and nickel oxide are non-limiting examples of materials that may be added to an electrode active material layer to improve its energy density, among other benefits.

One particular example is the use of silicon in lithium-ion batteries. Silicon based anode active materials have potential as a replacement for the carbon material of conventional lithium-ion battery anodes due to silicon's high theoretical lithium storage capacity of 3500 to 4400 mAh/g. Such a high theoretical storage capacity could significantly enhance the energy density of the lithium-ion batteries. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon can cause particle cracking and pulverization when the silicon has no room to expand. This expansion also leads to electrode delamination, loss of porosity, electrical isolation of the active material, increase in electrode thickness, rapid capacity fade and ultimate cell failure.

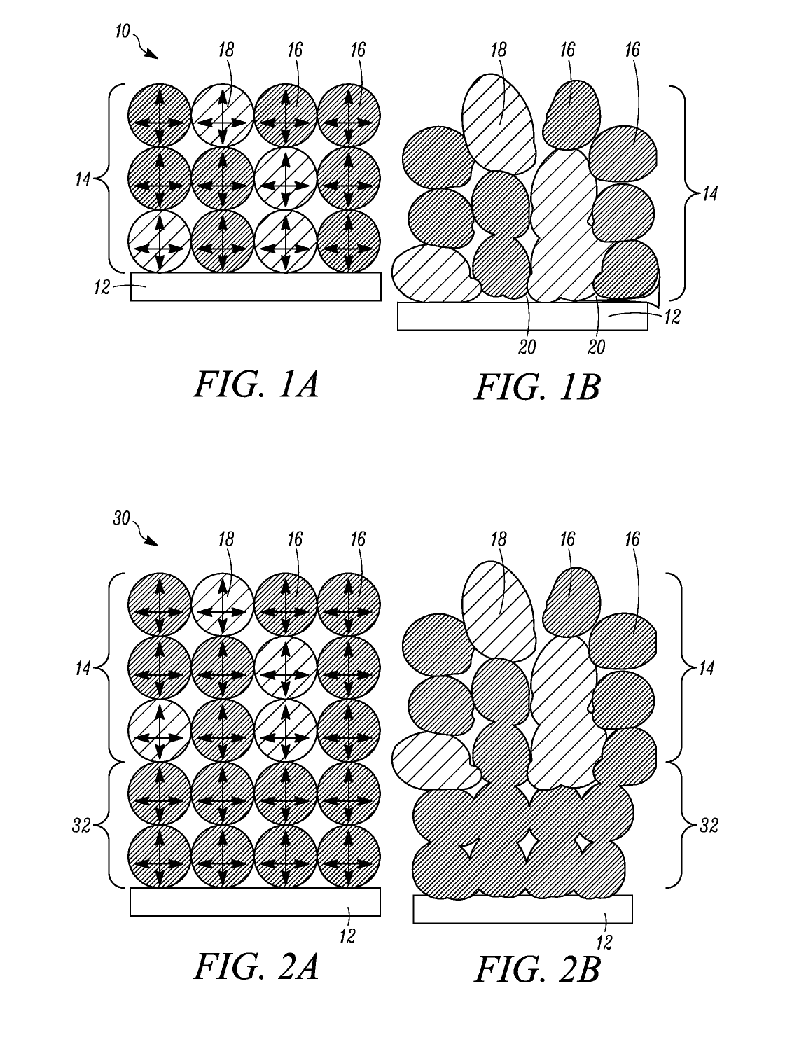

FIGS. 1A and 1B illustrate a conventional electrode 10. The conventional electrode 10 comprises a current collector 12, on which an active material layer 14 is deposited. For illustrative purposes, the active material layer 14 comprises graphite 16 and silicon 18. However, the silicon 18 can be another material used to increase the energy density and capacity of a graphite electrode. FIG. 1A illustrates the conventional electrode 10 prior to use, with the active material layer 14 deposited directly on the current collector 12. No lithiation has occurred, so no expansion of the material has occurred. FIG. 1B illustrates the conventional electrode 10 after use, when the electrode has been lithiated. Although not to scale, FIG. 1B illustrates the small volume increase of particles of graphite 16 compared to the large volume increase of the silicon particles 18. As the silicon particles 18 expand, the shape of each particle varies as it expands into available voids. This reduces the porosity across the active material layer 14. Particles on the bottom of the active material layer 14 suffer the greatest mechanical stress and pressure. This can cause delamination (illustrated by gaps 20) between the active material layer 14 and the current collector 12. As cycling of the battery continues, delamination increases. As the contact between the current collector 12 and active material layer 14 worsens, polarization of the electrode 10 increases and electrode capacity drops. As the silicon particles 18 continue to exert pressure due to expansion on neighboring particles, particle cracking and other damage can occur. Porosity of the active material layer 14 is also lowest at the bottom of the active material layer 14 due to the greater mechanical stress and pressure, which contributes to the increase in polarization and the decrease in electrode capacity. The effects are increased as the amount of silicon 18 in the active material layer 14 increases, and as the thickness of the active material layer 14 increases.

Disclosed herein and illustrated in FIGS. 2A and 2B are electrodes 30 having a conductive buffer layer 32 between the current collector 12 and the active material layer 14 configured to reduce or eliminate delamination from the current collector 12, increase porosity of the electrode 30, and accommodate swelling of the silicon 18 in the active material layer 14. FIG. 2A illustrates an embodiment of the disclosed electrode 30 prior to use, with the buffer layer 32 formed on the current collector 12 and the active material layer 14 deposited on the buffer layer 32. No lithiation has occurred, so no expansion of the material has occurred. FIG. 2B illustrates the disclosed electrode 30 after use, when the electrode has been lithiated. Because the buffer layer 32 comprises particles that undergo minimal expansion when lithiated, there is little to no delamination between the buffer layer 32 and the current collector 12. The buffer layer 32 also acts as a sponge to accommodate swelling of the silicon 18 in the active material layer 14 above the buffer layer 32. The porosity of the electrode 30 is maintained near the current collector 12 with the use of the buffer layer 32, and less reduction of the porosity across the active material layer 14 occurs due to the buffer layer 32.

The conductive buffer layer 32 can include one or more of graphene, graphite, carbon nanotubes, carbon black and the like. The conductive buffer layer 32 can further include a binder, such as any commercially available binders known to those skilled in the art. The conductive buffer layer 32 can further include a conductive additive, such as any commercially available conductive additives known to those skilled in the art. One conductive buffer layer 32 consists essentially of a carbon and a binder, with the carbon being one or more of graphene, graphite, carbon nanotubes, carbon black and the like. The ratio by volume of carbon to binder should be greater than eighty percent.

The conductive buffer layer 32 has a thickness sufficient to accommodate the swelling of the particles in the active material layer that the buffer layer supports, while maintaining the requisite electrode thickness. The conductive buffer layer 32 can be, for example, two microns in thickness or greater. The thickness of the conductive buffer layer 32, for example, may be increased as the concentration of expansive particles such a silicon increases in the active material layer.

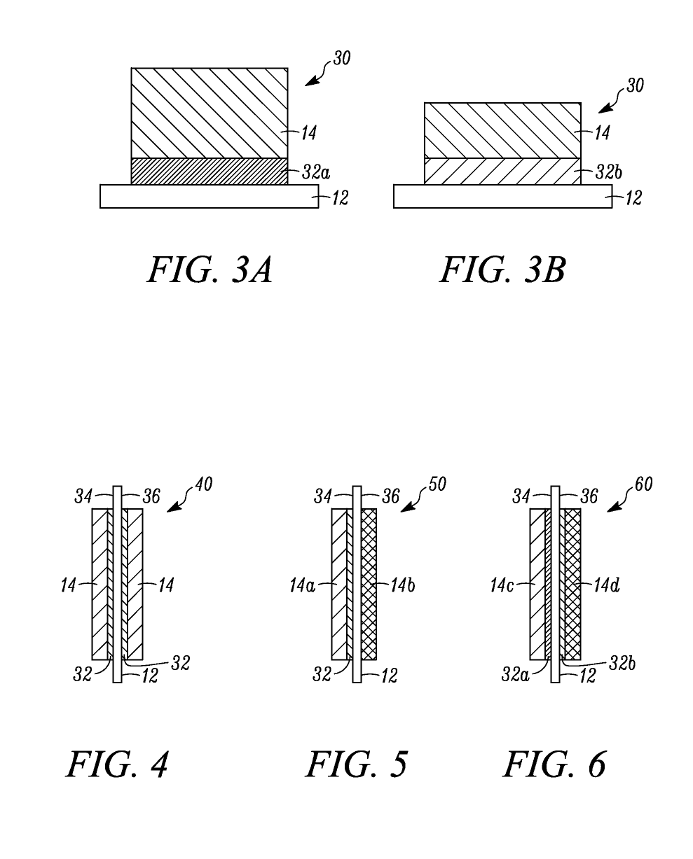

As illustrated in FIGS. 3A and 3B, the porosity of the conductive buffer layer 32 can be adjusted depending on the characteristics of the active material layer 14. For example, the active material layer 14 in FIG. 3A is greater in thickness than the active material layer 14 in FIG. 3B. To accommodate this increased thickness, the buffer layer 32a in FIG. 3A has a greater porosity than the porosity of the buffer layer 32b in FIG. 3B. As another example, as a concentration of an expansive particle increases in the active material layer 14, the porosity of the buffer layer 32 can increase to accommodate the swelling of the increased concentration of the expansive particles.

FIGS. 4-6 illustrate various embodiments of electrodes disclosed herein. Each of the electrodes includes a current collector 12. The material of the current collector 12 can be a metal foil such as nickel, iron, copper, aluminum, stainless steel and carbon, as non-limiting examples, depending on the type of battery in which the electrode is used. FIG. 4 is a cross sectional view of an electrode 40 disclosed herein including a conductive buffer layer 32 on each opposing surface 34, 36 of the current collector 12. The active material layer 14 is deposited on each buffer layer 32. In this embodiment, the active material layer 14 is the same on both sides of the current collector 12. The electrode 40 can be an anode or a cathode depending on the material of the active material layer 14 and the type of battery in which the electrode 40 will be used. As illustrated, the buffer layer 32 is only required between the current collector 12 and the active material layer 14, so it is not required to cover the entire surface of the current collector 12.

FIG. 5 is a cross sectional view of another electrode 50 disclosed herein including a conductive buffer layer 32 on only one surface 34 of the current collector 12. An active material layer 14a is deposited on the buffer layer 32. In this embodiment, the electrode is a bi-polar electrode and the active material layer 14a on the buffer layer 32 is different from the active material layer 14b deposited directly on the opposing surface 36 of the current collector 12. The buffer layer 32 and active material layer 14a can be an anode or a cathode depending on the material of the active material layer 14a and the type of battery in which the electrode 50 will be used. As illustrated, the buffer layer 32 is only required between the current collector 12 and the active material layer 14a, so it is not required to cover the entire surface of the current collector 12.

FIG. 6 is a cross sectional view of an electrode 60 disclosed herein including a conductive buffer layer 32a, 32b on each opposing surface 34, 36 of the current collector 12. One active material layer 14c is deposited on one buffer layer 32a while a different active material layer 14d is deposited on the other buffer layer 32b. In this embodiment, active material layers 14c, 14d are different on each side of the current collector 12, such as a bi-polar electrode. As illustrated, the buffer layer 32a, 32b is only required between the current collector 12 and the active material layers 14c, 14d, so it is not required to cover the entire surface of the current collector 12. The carbon material, thickness and porosity of each buffer layer 32a, 32b can vary depending on the characteristics of the corresponding active material layers 14c and 14d as described above. The buffer layers can also be the same carbon material, thickness and porosity.

Examples of the active material in the active material layers 14a-14d may include one or more materials selected from silicon, tin, sodium, sulfur, lithium, cobalt oxide, manganese oxide, nickel oxide and their compounds, such as lithium-transition metal composite oxides such as LiMn₂O₄, LiCoO₂, LiNiO₂, Li(Ni—Co—Mn)O₂ lithium-transition metal phosphate compounds, and lithium-transition metal sulfate compounds. These are provided by means of example and are not meant to be limiting.

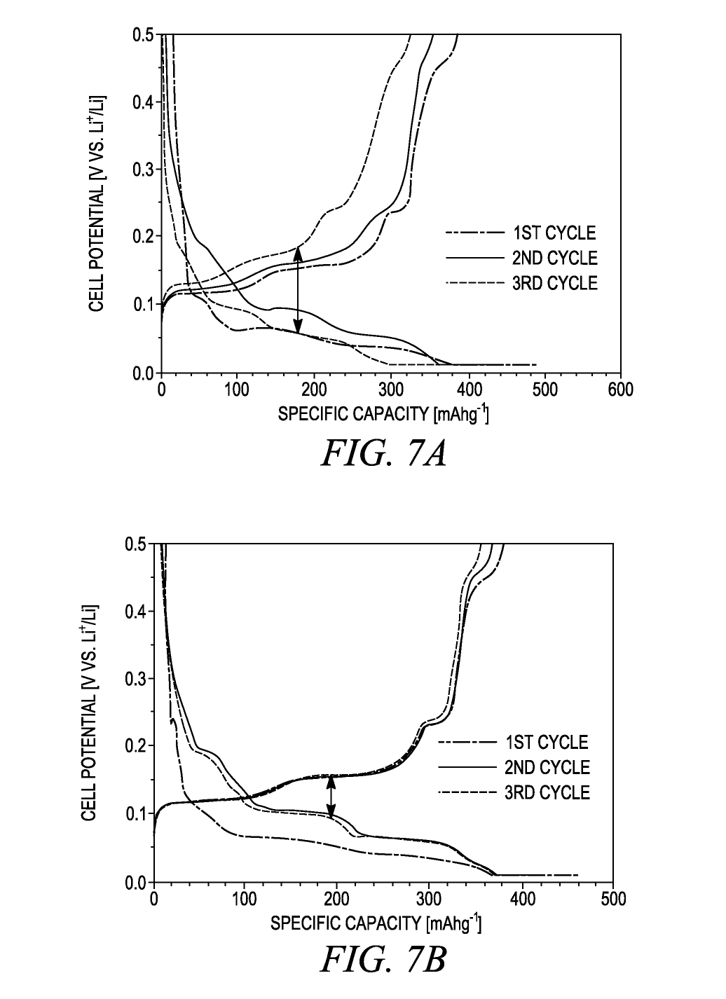

FIGS. 7A and 7B illustrate the improvement in polarization of the electrode realized when a conductive buffer layer as disclosed herein is included in the electrode. The electrode producing the results shown in FIG. 7A was a conventional electrode prepared with an active material layer of a graphite/4% silicon composite, with a graphite to silicon ration of 92%. PVDF was used as the binder at 6% and a conductive additive was used at 2%. FIG. 7A is a graph of cell potential versus specific capacity, with the arrow indicating the polarization occurring after the third cycle. The electrode producing the results shown in FIG. 7B was an electrode as disclosed herein, prepared with the same active material layer at that used in FIG. 7A, but with a buffer layer formed between the current collector and the active material layer. The buffer layer comprises 92% graphite, 6% PVDF binder and 2% of a conductive additive. The cell potential versus specific capacity graph of FIG. 7B results in a significantly reduced polarization after the third cycle, as illustrated with the arrow.

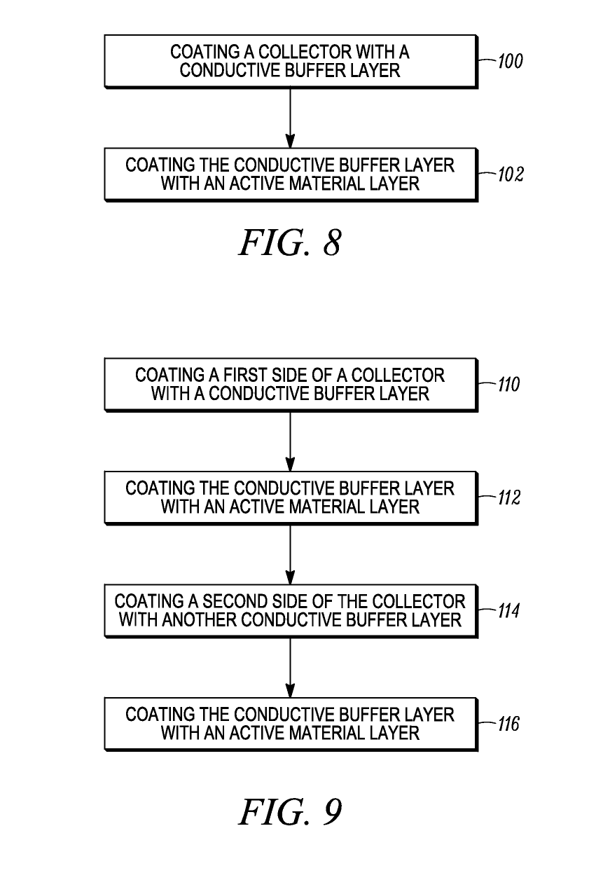

Also disclosed herein are methods of making the electrodes described with reference to the figures. FIG. 8 is a flow diagram of a method of making an electrode comprising coating a current collector with a conductive buffer layer in step 100 and coating the conductive buffer layer with an active material layer in step 102. Coating of the buffer layer and/or the active material layer can be accomplished by rolling, spraying, printing, vapor deposition or any other method known to those skilled in the art of electrode fabrication. The buffer layer can be dried prior to coating the active material layer on it.

FIG. 9 is flow diagram of another electrode preparation method disclosed herein comprising coating a first side of a current collector with a conductive buffer layer in step 110, coating the conductive buffer layer with an active material layer in step 112, coating a second side of the current collector with a conductive buffer layer in step 114 and coating the conductive buffer layer with an active material layer in step 116 which can be the same or different from the active material layer of the other side. Alternatively, the buffer layers can be serially deposited, with the active material layers being serially formed thereafter.

As described herein, the processes include a series of steps. Unless otherwise indicated, the steps described may be processed in different orders, including in parallel. Moreover, steps other than those described may be included in certain implementations, or described steps may be omitted or combined, and not depart from the teachings herein.

All combinations of the embodiments are specifically embraced by the present invention and are disclosed herein just as if each and every combination was individually and explicitly disclosed, to the extent that such combinations embrace operable processes and/or devices/systems. In addition, all sub-combinations listed in the embodiments describing such variables are also specifically embraced by the present device and methods and are disclosed herein just as if each and every such sub-combination was individually and explicitly disclosed herein.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An electrode comprising:
a current collector;
a conductive buffer layer formed on the current collector and consisting essentially of carbon and a binder; and
an active material layer formed on the buffer layer.

2. The electrode of claim 1, wherein the carbon of the buffer layer is one or both of graphite or graphene.

3. The electrode of claim 1, wherein the carbon of the buffer layer is one or both of carbon black and carbon nanotubes.

4. The electrode of claim 1, where the electrode is a cathode.

5. The electrode of claim 4, wherein the active material layer comprises one or more materials selected from the group consisting of sulfur, lithium, cobalt oxide, manganese oxide, nickel oxide and their compounds.

6. The electrode of claim 1, wherein the electrode is an anode.

7. The electrode of claim 6, wherein the active material layer comprises one or more materials selected from the group consisting of silicon, tin, lithium, sodium and their compounds.

8. The electrode of claim 1, wherein the current collector comprises one or more materials selected from the group consisting of nickel, stainless steel, copper, aluminum and carbon.

9. The electrode of claim 1, wherein the buffer layer is at least two microns in thickness.

10. The electrode of claim 1, wherein the carbon of the buffer layer is selected to have an increased porosity as a thickness of the active material layer is increased.

11. The electrode of claim 1, wherein the carbon of the buffer layer is selected to have an increased porosity as a concentration of silicon or tin in the active material layer is increased.

12. A lithium ion battery comprising the electrode of claim 1, wherein the electrode is an anode, the active material layer comprises graphite and silicon, and the carbon of the buffer layer is graphite.

13. A method of making an electrode configured to reduce polarization and improve energy density, the method comprising:
coating a first surface of a current collector with a conductive buffer layer consisting essentially of carbon and a binder; and
coating the buffer layer with an active material layer comprising a binder.

14. The method of claim 13, further comprising:
coating a second surface of the current collector with the conductive buffer layer; and
coating the buffer layer on the second surface with the active material layer.

15. The method of claim 13, wherein the carbon of the buffer layer is one or both of graphite or graphene.

16. The method of claim 13, wherein the active material layer comprises one or more materials selected from the group consisting of silicon, tin, sodium, sulfur, lithium, cobalt oxide, manganese oxide, nickel oxide and their compounds.

17. The method of claim 13, wherein the current collector one or more materials selected from the group consisting of nickel, stainless steel, copper, aluminum and carbon.

18. The method of claim 13, wherein the buffer layer is at least two microns in thickness.

19. The method of claim 13, wherein the carbon of the buffer layer is selected to have an increased porosity as a thickness of the active material layer is increased.

20. The method of claim 13, wherein the carbon of the buffer layer is selected to have an increased porosity as a concentration of silicon or tin in the active material layer is increased.
